(19) United States
(12) Patent Application Publication
(10) Pub. No.: US 2013/0133982 A1
(43) Pub. Date: May 30, 2013

(54) HOIST

(71) Applicant: Ulrich Graf, Donauworth (DE)

(72) Inventor: Ulrich Graf, Donauworth (DE)

(73) Assignee: GEDA-DECHENTREITER GMBH & CO. KG, Asbach-Baumenheim (DE)

(21) Appl. No.: 13/477,708

(22) Filed: May 22, 2012

(30) Foreign Application Priority Data
May 30, 2011 (DE) 10 2011 102 815.7

(51) Int. Cl. B66B 7/06; B66B 9/187

(52) U.S. Cl. CPC B66B 7/064; B66B 9/187
USPC 187/239

(57) ABSTRACT

The invention relates to a hoist having a guideway, a car which is movable along the guideway, and a cable extending between the car and a base station of the guideway, wherein at least one section of the cable is stored in a cable container in the region of the base station. The cable is guided by at least one deflecting device of a cable trolley which is movable along the guideway. A method for assembly and disassembly of a hoist of this type is also presented.

This application claims priority to German Patent Application No. DE 10 2011 102 815.7, filed May 30, 2011.

### BACKGROUND OF THE INVENTION

1. Field of the Invention

The invention relates to a hoist, in particular an external hoist as used, for example, as a building site hoist. The invention also relates to the assembly and disassembly of a hoist of this type.

2. Description of Related Art

External hoists are used, for example, in building sites for high-rise buildings, in order to transport personnel and materials to the upper levels of the building to be constructed or refurbished.

External hoists of this type frequently have a guideway which is fastened to one of the walls of the building and therefore often extends in a vertical direction. The guideway consists of one or two mast towers on which a car is movably mounted. The car serves to accommodate the persons or the goods to be carried.

The mast towers therefore serve to guide the movement of the car and can also comprise part of the drive train. As a rule, for this purpose, at least one of the mast towers is provided with at least one rack which extends in the longitudinal axial direction of the guideway and in which a pinion of an electrical drive system engages. In hoists of this type, the drive system is thus accommodated in the region of the car and is therefore moved with the car.

Due to the considerable output of the drive system of such hoists, such systems are almost without exception supplied with electrical energy via cables. In the case of a drive system carried with the car, the cable must therefore have a sufficient length to permit the movement of the car to the highest position thereof on the guideway. However, hoists of this type reach guideway heights of up to several hundred meters, which places great demands on the storage and guidance of the cable. In particular, the cable must be securely stored in the region of a base station of the hoist when the car is in a position relatively far down on the guideway. In some cases, several hundred meters of cable must be stored in a space-saving manner and such that elongation or shortening of the cable section connecting the base station to the car can be achieved without difficulty. It must be possible to perform such elongation or shortening over many cycles without damaging the cable and without the cable becoming snagged or self-entangled. In addition, uncontrolled cable movement in the region of the base station of the hoist should be avoided since this is associated with considerable risk to persons and materials situated in the vicinity.

In many cases, the cables are simply laid more or less evenly in a round upwardly open cable container or cable trough.

An improved possibility for storing the not “required” section of a cable of a hoist of this type is disclosed by DE 20 2007 015 008 U1. It is provided therein that the cable configured as a flat cable is laid in meandering manner in a narrow container. In this way, an extremely even storage of the not “required” section of the cable can be achieved, which also reliably prevents snagging or entanglement and occupies little space.

Regardless of these advantages, the manner of guidance and storage of a cable known from DE 20 2007 015 008 U1 is not optimal for a hoist with a relatively high running frame. In particular, the long cable required for a hoist of this type is subject to severe loading during operation by the cyclical stacking and unstacking. This applies, in particular, to the lower section of the cable which is loaded by the high weight of the long section lying thereon.

For the reasons cited above, particularly in the case of hoists with a relatively high guideway, “cable trolleys” which have a deflection roller, over which the section of the cable extending between the car and the base station is guided, are used. The section of the cable coming from the base station is fixed at approximately half the height of the chassis. The section between the fixing and the car has a length which enables the car to reach the highest and lowest stop positions on the guideway. Uncontrolled oscillation movements of the upper section of the cable, i.e. the section extending between the fixing and the car is prevented by the cable trolley.

An essential advantage of this type of cable guidance lies therein that no cable trough is needed in the region of the base station in order to accommodate the not “required” section of the cable dependent on the position of the car. Rather, this section of the cable is guided in a loop over the deflection roller of the cable trolley. However, a disadvantage of a cable guide of this type is the substantial effort required for the assembly and disassembly of the hoist. During assembly and disassembly of the hoist, individual sections of the mast towers (mast segments) are placed upon one another and connected to one another, or separated from one another, piece by piece from the car. The cable trolley is assembled/disassembled only after approximately half the running frame height is reached and following the fixing/release of the lower cable section which only then is possible. Until then or from that point, the entire remaining length of the cable is stored in the region of the base station. This requires not only suitably generous space, but can also lead to damage of the cable since the cable is stored—due to the lack of ordered storage such as, for example, a cable trough according to DE 20 2007 015 008 U1 would enable—relatively disorganized and is therefore stacked and unstacked multiple times due to the travel movements of the car during assembly/disassembly with relatively high wear.

### SUMMARY OF THE INVENTION

Bearing in mind the problems and deficiencies of the prior art, it is therefore an object of the present invention to provide an improved hoist. Furthermore, an advantageous method for assembly and disassembly of such a hoist is to be provided.

Still other objects and advantages of the invention will in part be obvious and will in part be apparent from the specification.

The above and other objects, which will be apparent to those skilled in the art, are achieved in the present invention which is directed to a hoist comprising a guideway, a car which is movable along the guideway, and a cable extending between the car and a base station of the guideway, including at least one section of the cable stored in a cable container in the region of the base station, such that the cable is guided over at least one deflecting device of a cable trolley which is movable along the guideway. The cable trolley is guided on the guideway. The cable container may be displaceable, pivotable, or both, in a direction perpendicular to the longitudinal axis of the guideway.

A cable holder may be fastened between the cable container and the cable trolley on the guideway for fixing the cable. The cable holder is preferably fastened at approximately half height on the guideway.

One or more cable guides may be arranged along the guideway.

In a second aspect, the present invention is directed to a method for assembly of a hoist, including extending the guideway by successive placement of individual guideway segments up to a total length, wherein the guideway segments are placed from a car which is movable along an already existing guideway section, such that after reaching approximately half the total length, a cable trolley is assembled.

The method may include pulling the cable out of, or laid into, a cable container dependent on the movement of the car, until the cable trolley is assembled.

The method may also include, for the assembly of the cable trolley, pulling the cable out of the cable container up to the length necessary for reaching the total length of the guideway and then fastening to the guideway by a cable holder.

In a third aspect, the present invention is directed to a method for disassembly of a hoist including shortening a guideway by successive removal of individual guideway segments starting from a total length, wherein the guideway segments are removed from within a car which is movable along the still existing guideway section, such that before approximately half of the total length is reached, a cable trolley is disassembled.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 shows, in an isometric view, a hoist according to the invention in a first phase of assembly;

FIG. 2 shows the hoist of FIG. 1 in a schematic side view;

FIG. 3 shows the hoist of FIG. 1 in a schematic partial plan view;

FIG. 4 shows, in an isometric view, the hoist of FIG. 1 in a second phase of assembly;

FIG. 5 shows the hoist of FIG. 4 in a schematic side view; and

FIG. 6 shows the hoist of FIG. 4 in a schematic partial plan view.

### DESCRIPTION OF THE PREFERRED EMBODIMENT(S)

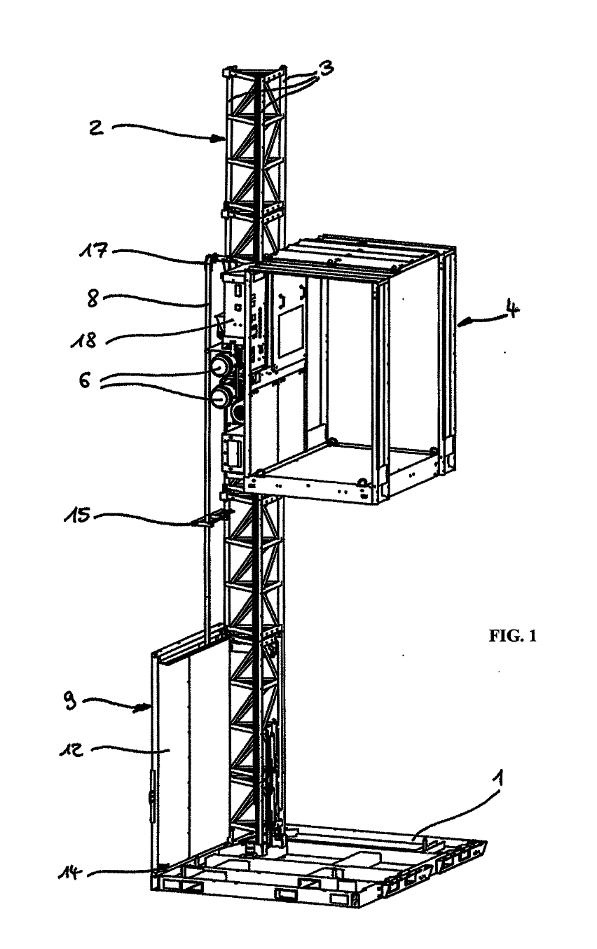

In describing the preferred embodiment of the present invention, reference will be made herein to FIGS. 1-6 of the drawings in which like numerals refer to like features of the invention.

The invention is based on the concept not only of equipping a hoist of the type in question, as known from DE 20 2007 015 008 U1, with a cable container which accommodates the not “required” cable section dependent on the respective position of the car on the running frame, but also of providing a cable trolley which is movable along the guideway, said cable trolley having at least one deflection device (preferably a deflection roller) over which the cable, which extends from a base station of the guideway to the car, is guided.

The embodiment of a hoist according to the invention has advantages, particularly in the assembly and disassembly of the hoist, which enable the cable to be stored securely and protectively (packed) in the cable container until assembly of the cable trolley which preferably takes place shortly after reaching half the guideway height.

A method for assembly of a hoist according to the invention, the guideway of which is elongated by the placement of individual guideway segments upon one another up to a total length, wherein the guideway segments are placed from the movable car along the already existing guideway section is characterized according to the invention in that the cable trolley is assembled after reaching approximately, and preferably somewhat more than, half the total length of the guideway.

The cable can therefore be pulled out of the cable container during assembly—according to the positional displacement of the car—or laid therein. This can be provided until approximately half the total length of the guideway is reached; then, according to the invention, the assembly of the cable trolley is carried out wherein it can previously be provided that the cable is fixed at approximately half the height of the total length of the guideway by a cable holder fastened to the guideway. Previously thereto, the cable can be pulled out of the cable container far enough such that the car can reach both end positions on the guideway without the fixing of the cable in the cable holder having to be released again.

Therefore, following assembly of the cable trolley, preferably no further pulling out or placement of the cable from/into the cable container takes place but rather the respective excessive cable length is guided—depending on the position of the car—in a loop via the deflecting device of the cable trolley. During operation of the fully assembled hoist, the cable container can therefore “only” have the task of taking up a possibly not “required” section of the cable in protected manner. Such a not “required” section can, for example, result from the cable that is used allowing for the assembly of a guideway having a greater total length than is provided in an individual case.

A method for disassembly of a hoist according to the invention, the guideway of which is successively shortened by removal of individual guideway segments starting from a total length, wherein the guideway segments are removed from the car which is movable along the still existing guideway section is characterized according to the invention in that the cable trolley is disassembled before reaching approximately, and preferably somewhat more than, half the original total length of the guideway.

In a preferred embodiment of the hoist according to the invention, it can be provided that the cable trolley is also guided at the guideway. By this means, it is possible to prevent the cable trolley being caused—for example, by means of wind movement—to oscillate, such that the cable guide might be hindered.

The cable trolley of the hoist according to the invention can be configured so as to be always arranged beneath the car. With this configuration of the hoist, in particular, it can be provided that the cable container is displaceable or pivotable in a direction perpendicular to the longitudinal axis of the guideway, so that a collision of the cable trolley with the cable container can be prevented on reaching the base station.

The hoist shown in the drawings comprises a base station 1, from which a guideway 2 extends in a vertical direction. The guideway 2 comprises individual guideway segments that are connected to one another. The guideway segments are built as a framework from struts connected to one another, wherein three vertical struts 3 extending mutually parallel, connected to one another via a plurality of transverse struts, are provided. The cross-section of the guideway 2 is triangular. A car 4 is movably arranged at one of the sides of the guideway 2. For this purpose, a plurality of guide rollers 5 is provided which roll along the two corresponding vertical struts 3. Car 4 comprises a drive system with two electric motors 6 the drive pinions of which engage in a toothed rack 7 which is fastened to one of the vertical struts 3 and extends parallel thereto. Car 4 can be driven along the guideway 2 by the operation of the electric motors 6.

Electric motors 6 are supplied with energy via an electrical cable 8. Cable 8 extends between car 4 and base station 1 where the cable can be connected to an electrical energy source. As a result of the travelling movement of car 4, the distance between car 4 and base station 1 changes and, therefore also the length of the (“required”) cable section running along the guideway 2. The not “required” section of cable 8, dependent on the respective position of car 4 is to be stored such that snagging or entanglement of cable 8 is prevented and friction-induced wear is minimized. This is accomplished with the hoist according to the invention both by cable container 9 and also by a cable trolley 11 comprising a deflecting device, specifically a deflecting roller 10.

FIGS. 1 to 3 show the hoist during assembly and before the guideway 2 has reached a height that is approximately half the total length provided for later operation. For the assembly, the individual guideway segments are successively placed upon, and connected to, one another. This is achieved from car 4, the car being moved close to the upper end of the already assembled guideway section so that a further guideway segment can be (manually) placed thereon. Car 4 can only accommodate a limited number of guideway segments. Thus, the car must only be moved back to base station 1 once all the previously loaded guideway segments have been assembled, in order to be able to load new guideway segments. Car 4 is also moved several times between base station 1 and the respective upper end of the guideway 2 during assembly of the hoist. During this process, cable 8, the length of which is configured so as to be suitable for operation of the fully assembled hoist, and which therefore has at least the planned total length of the guideway 2, must be reliably guided and (the not “required” section) must be stored.

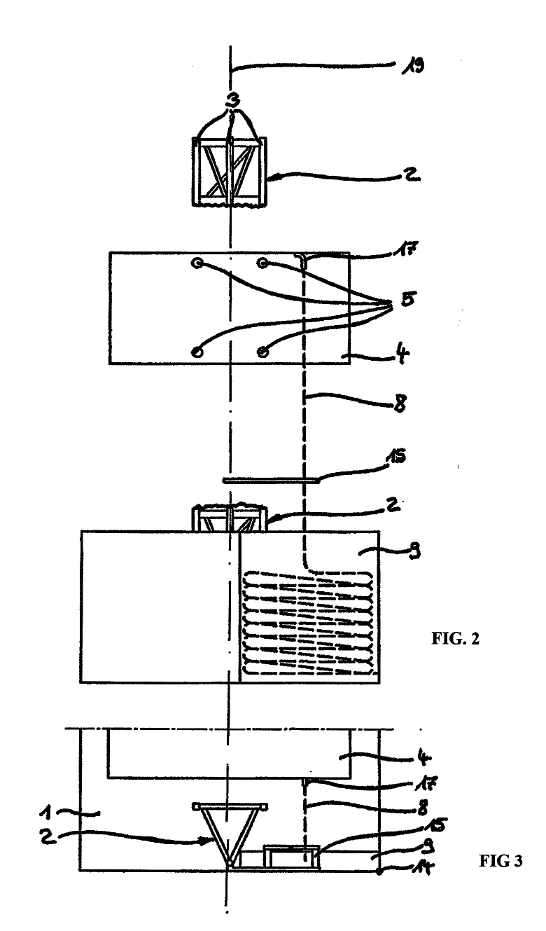

This is achieved, during assembly of up to approximately, and preferably somewhat more than, half the total length of the guideway 2, with the aid of the cable container 9. Cable container 9 has, in the exemplary embodiment shown, a cuboid-shaped housing 12, the upper side of which (facing in the direction of the upper end of the guideway) is open. The breadth of the housing 12 of cable container 9 is several times greater than the depth thereof. This configuration of cable container 9 makes it possible for cable 8 to be laid in meandering fashion in cable container 9, as shown schematically in FIG. 2. The meandering cable storage in cable container 9 is—due to the stacking in the vertical direction—relatively space-saving, reliable, and is associated with relatively low wear on the cable.

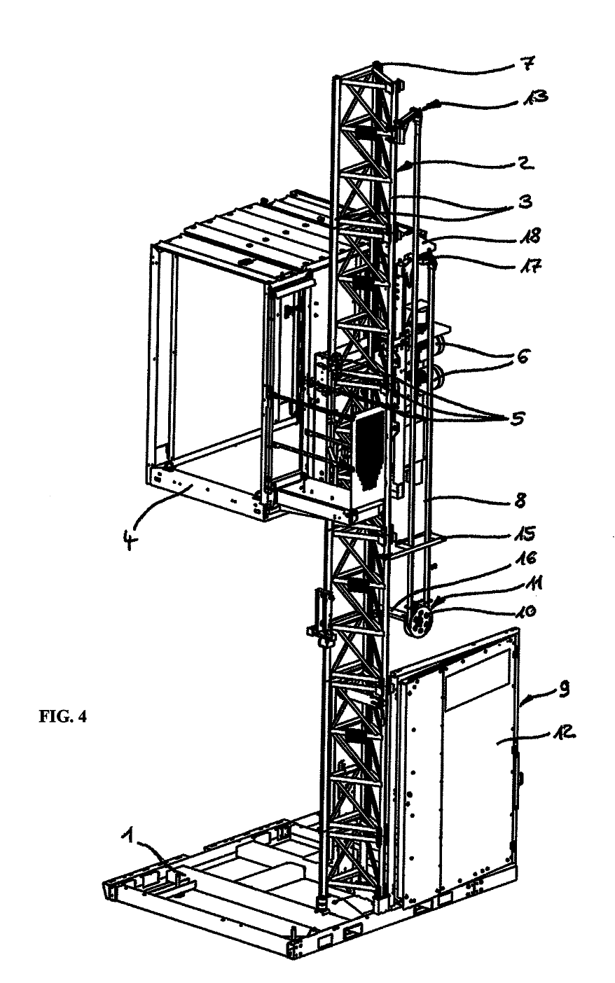

FIGS. 4 to 6 show the hoist after more than half the total length of the guideway 2 has been assembled. The hoist also comprises the cable trolley 11 over the deflection roller 10 of which a loop of cable 8 is guided. Cable trolley 11 is also guided—via guide rollers—on the same vertical struts 3 of the guideway 2 as car 4, cable trolley 11 being positioned beneath car 4.

For the assembly of cable trolley 11, cable 8 is initially pulled out of cable container 9 far enough such that the pulled-out cable section enables both the planned end positions of car 4 on the fully assembled guideway 2 to be reached and then fixed slightly above half the guideway height in a cable holder 13 fastened to the guideway 2 (see FIG. 3, where for the sake of clarity, the guideway is shown greatly foreshortened). The section of cable 8 which extends between cable holder 13 and car 4 has a length that is greater than the distance between cable holder 13 and car 4, the excess cable length changing dependent on the respective position of car 4. The excess cable length is guided in a loop over the deflection roller 10 of the cable trolley 11. When car 4 is moved, cable 8 is no longer pulled out of cable container 9 or laid in meandering fashion therein. Rather, the length compensation required to adjust for a changing position of the car is accomplished with a changing distance between car 4 and cable trolley 11. Cable trolley 11 moves in the same direction as car 4, however—due to the single deflection—at only half the speed. Cable container 9 then only contains a cable section not “required” for reaching the intended total length of the guideway (see FIG. 5).

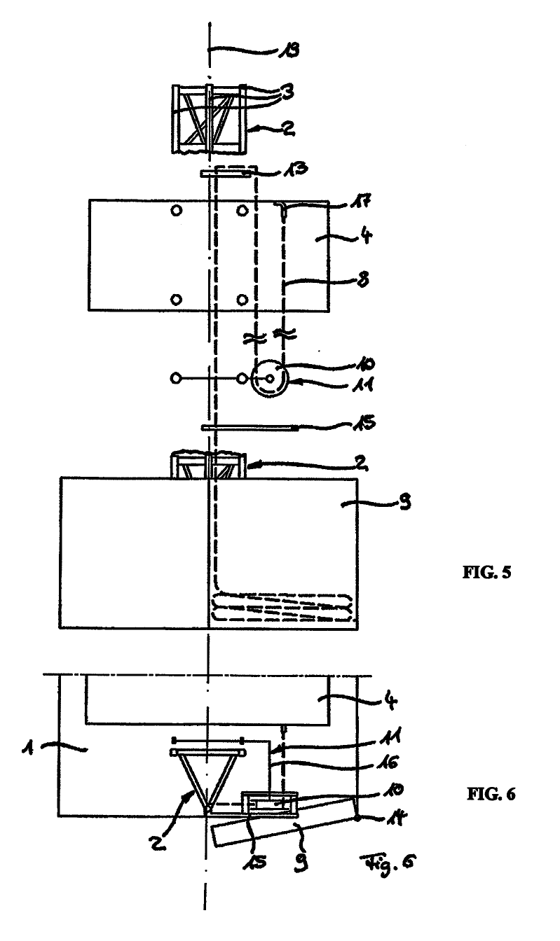

In order for the hoist with cable trolley 11 attached to be able to reach the lowest position in the region of base station 1, it is necessary to remove cable container 9 from the position shown in FIG. 1, in order to prevent a collision with the deflection roller 10 of cable trolley 11. This is achieved with the hoist shown in that cable container 9 is pivoted about an axis lying parallel to the longitudinal axis 19 of the guideway 2 (by only approximately 20 cm), as shown in FIGS. 4 and 6 (in FIG. 4, the section of cable 8 lying between cable container 9 and cable holder 13 is not shown for the sake of clarity). Cable container 9 is connected via a hinge 14 to base station 1 of the hoist.

The hoist shown is also provided with a plurality of cable guides 15 spaced apart from one another at the guideway 2 and also provided to prevent uncontrolled oscillation of the cable. Cable guides 15 each comprise a rectangular frame the side of which facing the car is formed from two elastically deformable partial struts. The cable is guided within the frame, which is dimensioned such that the deflection roller 10 of cable trolley 11 can also pass therethrough. The two elastically deformable partial struts of the frame, which support the deflection roller (10) permit the passage of a horizontal strut 16 of cable trolley 11 or of a fastening bracket 17 via which cable 8 is guided into switchgear cabinet 18 of the drive system.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A hoist comprising a guideway, a car which is movable along the guideway, and a cable extending between the car and a base station of the guideway, including at least one section of the cable stored in a cable container in the region of the base station, such that the cable is guided over at least one deflecting device of a cable trolley which is movable along the guideway.

2. The hoist of claim 1 wherein the cable trolley is guided on the guideway.

3. The hoist of claim 1 including the cable container being displaceable, pivotable, or both, in a direction perpendicular to the longitudinal axis of the guideway.

4. The hoist of claim 1 including a cable holder fastened between the cable container and the cable trolley on the guideway for fixing the cable.

5. The hoist of claim 4 including the cable holder being fastened at approximately half height on the guideway.

6. The hoist of claim 1 including one or more cable guides arranged along the guideway.

7. A method for assembly of a hoist, including extending the guideway by successive placement of individual guideway segments up to a total length, wherein the guideway segments are placed from a car which is movable along an already existing guideway section, such that after reaching approximately half the total length, a cable trolley is assembled.

8. The method of claim 7 including pulling the cable out of, or laid into, a cable container dependent on the movement of the car, until the cable trolley is assembled.

9. The method of claim 7, including, for the assembly of the cable trolley, pulling the cable out of the cable container up to the length necessary for reaching the total length of the guideway and then fastening to the guideway by a cable holder.

10. A method for disassembly of a hoist including shortening a guideway by successive removal of individual guideway segments starting from a total length, wherein the guideway segments are removed from within a car which is movable along the still existing guideway section, such that before approximately half of the total length is reached, a cable trolley is disassembled.

11. The hoist of claim 2 including the cable container being displaceable, pivotable, or both, in a direction perpendicular to the longitudinal axis of the guideway.

12. The hoist of claim 2 including a cable holder fastened between the cable container and the cable trolley on the guideway for fixing the cable.

13. The hoist of claim 3 including a cable holder fastened between the cable container and the cable trolley on the guideway for fixing the cable.

14. The hoist of claim 12 including the cable holder being fastened at approximately half height on the guideway.

15. The hoist of claim 13 including the cable holder being fastened at approximately half height on the guideway.

16. The hoist of claim 14 including one or more cable guides arranged along the guideway.

17. The hoist of claim 15 including one or more cable guides arranged along the guideway.

18. The method of claim 8, including, for the assembly of the cable trolley, pulling the cable out of the cable container up to the length necessary for reaching the total length of the guideway and then fastening to the guideway by a cable holder
